(19) United States
(12) Patent Application Publication
(10) Pub. No.: US 2001/0006389 A1
(43) Pub. Date: Jul. 5, 2001

(54) Electronic document distributing system, information display system, electronic conference system and terminal devices used for these systems

(76) Inventors: Katsuyuki Nanba, Sakai-Shi (JP); Sadafusa Tsuji, Tondabayashi-Shi (JP); Katsuhiko Asai, Takatsuki-Shi (JP); Masahiko Matsuura, Suita-Shi (JP); Makiko Mandai, Takatsuki-Shi (JP)

Correspondence Address: SIDLEY AUSTIN BROWN & WOOD, 717 NORTH HARWOOD, SUITE 3400, DALLAS, TX, 75201, US

(21) Appl. No.: 09/742,880

(22) Filed: Dec. 20, 2000

(30) Foreign Application Priority Data
Dec. 28, 1999 (JP) 11-374538
Jan. 6, 2000 (JP) 2000-000780

(51) Int. Cl. G06F 17/00

(52) U.S. Cl. 345/418

(57) ABSTRACT

An electronic document distributing system in which a sending terminal device is connected to a plurality of receiving terminal devices via a network. Electronic documents are sent from the sending terminal device to the receiving terminal devices via the network. Simultaneously, a signal to prohibit deletion of the electronic documents is sent, and if necessary, a signal to cancel the prohibition of deletion is sent. In each of the receiving terminal devices, when a power switch is turned off, when the receiving terminal device is disconnected from the network or when a specified time passes from the sending time of the electronic documents, the prohibition of deletion is cancelled. Such an electronic document distributing system can be structured into an electronic conference system which has a terminal display device which receives and stores information sent from a host device (an electronic document server) and displays the information on a display panel. On the display panel of the terminal display device, usually, an image designated by the host device is displayed, but an arbitrary desired image can be also displayed by a key operation. The terminal display device monitors the image designated by the host device, and even while the terminal display device is displaying another image, the display device can be controlled to display the designated image by a key operation.

This application is based on the application Nos. 11-374538 and 2000-780 filed in Japan, the contents of which are hereby incorporated by reference.

### BACKGROUND OF THE INVENTION

1. Field of the Invention

The present invention relates to an electronic document distributing system, an information display system, an electronic conference system and terminal devices used for these systems.

2. Description of Prior Art

In conferences and seminars, generally, the participants listen to the presenters watching paper handouts. Such handouts are necessary during the conference or the seminar but in most cases, become unnecessary after the conference or the seminar, which results in waste of paper resource. Therefore, in recent years, a system in which materials for a conference are distributed to terminal devices, e.g., personal computers of the participants as electronic documents is suggested.

In using such a system, if a participant erases the electronic documents for the conference or the seminar carelessly, the person who prepared the documents (the sender) will have to send the electronic documents to the participant again. Actually, if one or a plurality of participants erase the electronic documents, the sender will send the electronic documents only to the participants who erased the documents or will send the electronic documents to all the participants of the conference or the seminar. In the former case, the sender will have trouble to designate individual addresses of the participants who erased the documents. In the latter case, the participants who did not erase the electronic documents will receive the same documents again, and the documents will occupy an unnecessarily large part of the capacity of their respective terminal devices.

A possible way of preventing the problem is setting a password for inhibition of reversion and erasure of data. If this method is adopted in the system, all the participants have to know the password, otherwise the participants cannot revise nor erase the data after the conference or the seminar.

Incidentally, Japanese Patent Laid Open Publication No. 6-274136 disclosed an electronic conference system which comprises one host device and a plurality of display devices for the participants. The host device and each of the display devices are connected by cable or radio wave, and it is possible to send and receive control signals to and from both the devices.

Information sent from the host device is stored in storing sections of the respective display devices and simultaneously is displayed on the display devices, so that the participants can see the information. There are two ways of permitting the participants to see the information; one is a case in which the host (or the presenter) mainly controls the system; and the other is a case in which the participants mainly control the system.

In the former case, the participants do not have to operate the display devices. Only the host sends information from the host device to the display devices of the participants, and the display devices only function to display the information received.

In the latter case, after the host sends information to the display devices of the participants, each of the participants can operate his/her display device by himself/herself independently of the host device to see any desirable part of the information. Thus, each of the participants can look into the documents for the conference freely, and the operability of the system is improved.

However, in the latter case, the participants can individually display any desirable part of information sent from the host device, and some of them cannot follow or concentrate on the presentation of the host and may give trouble to the host or the other participants.

### SUMMARY OF THE INVENTION

An object of the present invention is to provide an electronic document distributing system and terminal devices which not only prevent waste of paper resource but also prevent careless erasure of an electronic document distributed to the terminal devices.

Another object of the present invention is to provide an information display device which can display any desired part of information sent from a host device and can return to a required part of the information immediately, and an information display system and an electronic conference system which adopt such information display devices.

In order to attain the objects, according to the present invention, in an electronic document distributing system, a sending terminal device is connected to a plurality of receiving terminal devices via a network. The sending terminal device comprises sending means for sending an electronic document, deletion prohibiting signal outputting means for outputting a signal to prohibit deletion of the electronic document, and cancel signal outputting means for outputting a signal to cancel the prohibition of deletion of the electronic document. Each of the receiving terminal devices comprises a memory for storing the electronic document sent from the sending terminal device, deletion prohibiting means for prohibiting deletion of the stored electronic document in response to the deletion prohibiting signal, and deletion permitting means for permitting deletion of the electronic document in response to the cancel signal.

In the electronic document distributing system according to the present invention, together with an electronic document, a signal to prohibit deletion of the electronic document is sent, and thereby, in the receiving terminal devices, deletion of the electronic document is prohibited. Consequently, careless deletion of the electronic document during the conference can be prevented. The sending terminal device also sends a signal to cancel the prohibition of deletion, and in response to the cancel signal, the receiving terminal devices permit deletion of the electronic document. Accordingly, deletion of the electronic document becomes possible without using a password, and the operability of the receiving terminal devices is improved.

Further, in the electronic document distributing system, each of the receiving terminal devices may be so structured that the prohibition of deletion of the electronic document is cancelled in response to a specified operation (for example, turning-off of a power switch or disconnection of the receiving terminal device from the network) or when a specified time passes from the time of sending the electronic document. Thus, deletion of an electronic document which may be no longer necessary is automatically permitted in response to a specified operation, whereby the operability of the receiving terminal device is further improved.

A terminal device according to the present invention is used in the electronic document system. The terminal device comprises: a receiving section for receiving an electronic document; a first memory section for storing the electronic document received from an external apparatus; a second memory section for receiving and storing a deletion prohibiting signal to prohibit deletion of the electronic document; deletion prohibiting means for prohibiting deletion of the electronic document stored in the first memory section in response to the deletion prohibiting signal; a power switch; and deletion permitting means for permitting deletion of the electronic document stored in the first memory section in response to an operation of the power switch.

The terminal device according to the present invention may comprise, in addition to the receiving section, the first memory section, the second memory section and the deletion prohibiting means, a detecting section for detecting whether or not the terminal device is connected to a network and deletion permitting means for permitting deletion of the electronic document when the detecting section detects that the terminal device is disconnected from the network.

Since the terminal device comprises not only means for prohibiting deletion of the electronic document received but also means for permitting deletion of the electronic document, the operability of the terminal device is good.

The second memory section of the terminal device may receive and store a sending time signal which indicates the time of sending the electronic document, and in this case, the deletion prohibiting means prohibits deletion of the electronic document based on the sending time signal. Preferably, the deletion prohibiting means permits deletion of the electronic document when a specified time passes from the sending time.

It is preferred that the terminal device according to the present invention further comprises a display section with a memory effect and a control section for controlling the display section to display a first page of the electronic document when deletion of the electronic document is permitted. Thereby, the user can recognize what the conference and the electronic document were like even after the power supply to the display section is stopped.

A first information display device according to the present invention comprises: a communicating section for communicating with a host device; a display panel for displaying an image thereon; and detecting means for detecting information about an image designated by the host device. Because of the detecting means, the information display device can always obtain information about the image designated by the host device.

If the information display device further comprises a display control section for controlling the display device to display desired information on the display panel, even while the user of the display device is skimming the electronic document freely, the display device always recognizes the image designated by the host device. This facilitates a return of the display panel to the image designated by the host device.

Further, if the detecting means comprises a first indicator for indicating information about the image designated by the host device and a second indicator for indicating information about the image currently displayed on the display panel, the user can recognize the image designated by the host device directly.

A second information display device comprises: a communicating section for communicating with a host device; a display panel for displaying an image thereon; a display control section for controlling the display device to display desired information on the display panel; and display returning means for controlling the display device to display an image designated by the host device on the display panel. In this display device, even while the user is displaying desirable information on the display panel, if necessary, the display panel can be returned to the image designated by the host device quickly.

In both the first information display device and the second information display device, the display control section may control the display device to display, on the display panel, a desired part of information stored in a storage section which is provided inside or outside the display device.

A first information display system according to the present invention comprises a plurality of information display devices including a first information display device and a second information display device which comprises detecting means for detecting information about an image displayed on the first information display device. The user of the second information display device can always recognize the image displayed on the first information display device.

A second information display system according to the present invention comprises a host device and a terminal device which have respective display panels and which are capable of communicating with each other, and the terminal device comprises detecting means for detecting information about the image displayed on the display panel of the host device. The user of the terminal device can always recognize the image displayed on the display panel of the host device.

A third information display system according to the present invention comprises a plurality of information display devices including a first information display device and a second information display device which are capable of displaying desired information independently of each other, and the second information display device comprises display returning means for controlling the second information display device to display an image displayed on the first information display device. Even while the user of the second information display device is displaying desirable information, if necessary, the second information display device can be controlled to display the same image displayed on the first information display device quickly.

A fourth information display system according to the present invention comprises a host device and a terminal device which have respective display panels and are capable of communicating with each other, and the terminal device comprises display returning means for controlling the terminal device to display an image displayed on the display panel of the host device. Thereby, even while the user of the terminal device is displaying desirable information on the display panel, if necessary, the terminal device can be controlled to display the same image as that displayed on the display panel of the host device quickly.

An electronic conference system according to the present invention comprises a host device and one of the above-described information display devices. In this system, the participants of a conference, that is, the users of the information display devices can obtain information about an image designated by the host device or can control the respective display devices to display an image designated by the host device at any time. Therefore, the host can proceed the conference smoothly.

In the electronic conference system, the host device may comprise a display panel. From the display on the display panel, the host can recognize what image the host device designates to the participants. Also, the host can use this display panel for a presentation to the participants. In this case, the information about the image designated by the host device possibly means the information about the image displayed on the display panel of the host device.

### BRIEF DESCRIPTION OF THE DRAWINGS

These and other objects and features of the present invention will be apparent from the following description with reference to the accompanying drawings, in which:

FIG. 1 is a general structural view of an electronic document distributing system which is a first embodiment of the present invention;

FIG. 2 is a general structural view of an electronic document distributing system which is a second embodiment of the present invention;

FIG. 3 is a plan view of an operating section of a sending terminal device;

FIG. 4 is a front view which shows a front panel of a receiving terminal device;

FIG. 5 is a block diagram which shows a principal part of a control section of the sending terminal device;

FIG. 6 is a block diagram which shows a principal part of a control section of the receiving terminal device;

FIG. 7 is a sectional view of an exemplary liquid crystal display;

FIG. 8 is a plan view of a film type substrate of the liquid crystal display on which resin nodules and a sealant are provided;

FIG. 9 is an illustration which shows a manufacturing process of the liquid crystal display;

FIG. 10 is a block diagram which shows a driving circuit of the liquid crystal display;

FIG. 11 is a flowchart which shows a first example of a data sending procedure in the sending terminal device;

FIG. 12 is a flowchart which shows a second example of the data sending procedure in the sending terminal device;

FIG. 13 is a flowchart which shows a third example of the data sending procedure in the sending terminal device;

FIG. 14 is a flowchart which shows a fourth example of the data sending procedure in the sending terminal device;

FIGS. 15 and 16 are flowcharts which show a first example of a data receiving procedure in the receiving terminal device;

FIG. 17 is a flowchart which shows a second example of the data receiving procedure in the receiving terminal device;

FIG. 18 is a flowchart which shows a third example of the data receiving procedure in the receiving terminal device;

FIG. 19 is a flowchart which shows a fourth example of the data receiving procedure in the receiving terminal device;

FIG. 20 is a general structural view which shows an electronic conference system according to the present invention;

FIG. 21 is a perspective view of an information display device according to the present invention;

FIG. 22 is a plan view of an operating section of the information display device;

FIG. 23 is a perspective view of a control board of the information display device;

FIG. 24 is a block diagram which shows a control section of the information display device;

FIG. 25 is a plan view of another exemplary operating section of the information display device;

FIG. 26 is a flowchart which shows a page turning procedure carried out by a host device;

FIG. 27 is a flowchart which shows a page turning procedure carried out by the information display device;

FIG. 28 is a flowchart which shows a host display position monitoring procedure carried out by the information display device;

FIG. 29 is a flowchart which shows a returning procedure carried out by the information display device; and

FIG. 30 is a flowchart which shows a storing procedure carried out by the information display device.

### DETAILED DESCRIPTION OF THE PREFERRED EMBODIMENTS

Embodiments of an electronic document distributing system, an information display system and an electronic conference system according to the present invention and terminal devices which are used for the systems are described with reference to the accompanying drawings.

### General Structure of Electronic Document Distributing System

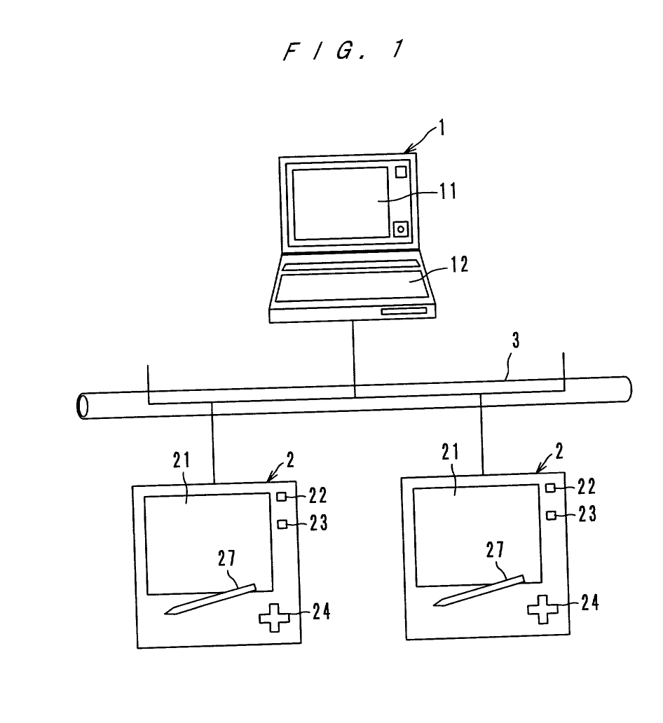

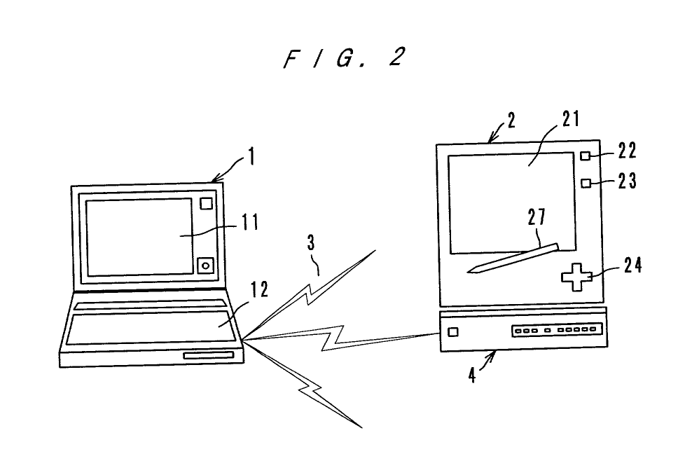

FIGS. 1 and 2 respectively show a first embodiment and a second embodiment of an electronic document distributing system according to the present invention. In the system, a sending terminal device 1 which is to send electronic documents is connected to a plurality of receiving terminal devices (document display devices) 2 via a network 3.

In the first embodiment shown by FIG. 1, the network 3 is a cable network. In the second embodiment shown by FIG. 2, the network 3 is wireless communication means such as radio communication means, infrared transmitting means, etc., and in this case, an adapter 4 is attached to each of the receiving terminal devices 2. In the first embodiment, each of the receiving terminal devices 2 may be connected to the network 3 directly or via an adapter. The terminal devices 1 and 2 may not be of exclusive use for data sending or for data receiving and may have the both functions as a sender and a receiver.

### Structure of Terminal Device

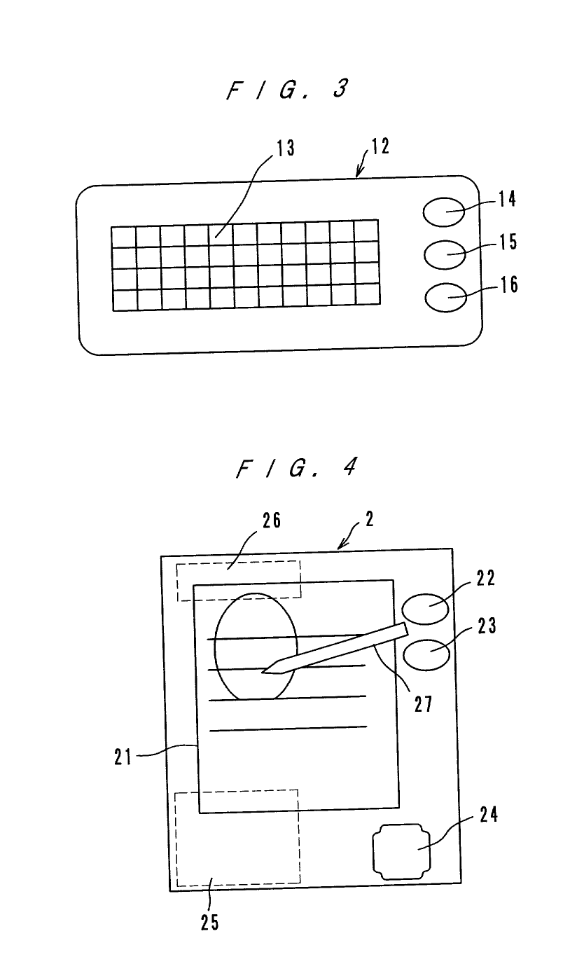

The sending terminal device 1 comprises a liquid crystal display 11 and an operating section 12. As FIG. 3 shows, the operating section 12 comprises a keyboard 13, a power switch 14, a send switch 15 for sending documents and a cancel switch 16 for canceling protection (canceling prohibition of deletion of the documents in the receiving terminal devices 2) . However, the switch 16 may not be necessary.

FIG. 4 shows a front panel of the receiving terminal device 2. On the front panel, a liquid crystal display 21, a power switch 22, a delete switch 23 for deleting documents and a four-way switch 24 are provided. Further, in the receiving terminal device 2, a storage medium 25 (a magnetic disk, an optical disk, a memory card or the like) which is to store documents received from the sending terminal device 1 therein can be inserted, and an interface 26 to connect the storage medium 25 to the network 3 is installed. Also, a stylus pen 27 is provided, so that the user can write data additionally to the image displayed on the liquid crystal display 21.

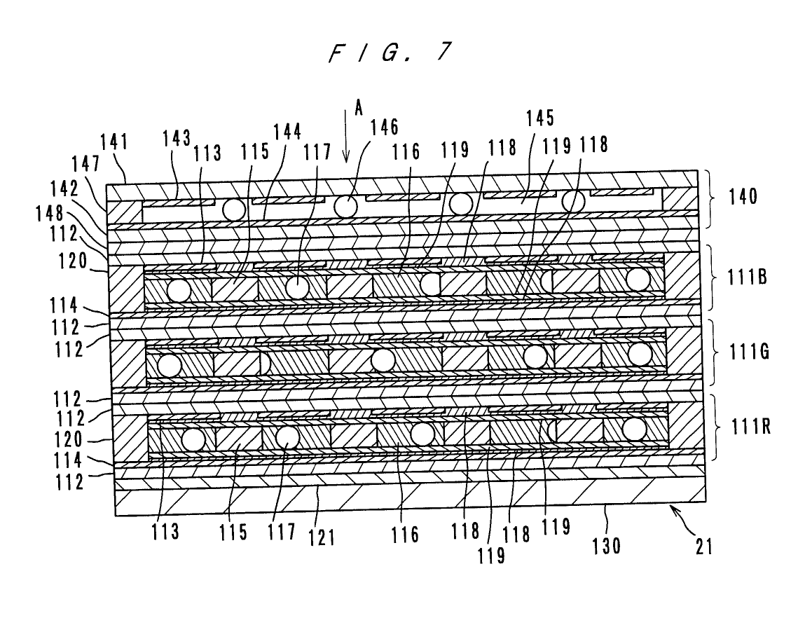

The liquid crystal display 21 is to display the documents and the data additionally written. As will be described referring to FIG. 7, in this embodiment, liquid crystal with a memory effect (chiral nematic liquid crystal, ferroelectric liquid crystal, polymer dispersed liquid crystal or the like) is used for the liquid crystal display 21, but it is not always necessary to use such liquid crystal with a memory effect. As will be described in detail later, on the surface of the liquid crystal display 21, a touch panel 140 which permits writing with the stylus pen 27 is provided. The liquid crystal display 11 employed in the sending terminal device 1 is basically of the same structure as the liquid crystal display 21 but is not provided with a touch panel.

The four-way switch 24 is of a conventional type. By operating the switch 24 right and left, the user can turn the pages forward and backward on the liquid crystal display 21. By operating the switch 24 up and down, the user can magnify and reduce the page displayed on the liquid crystal display 21.

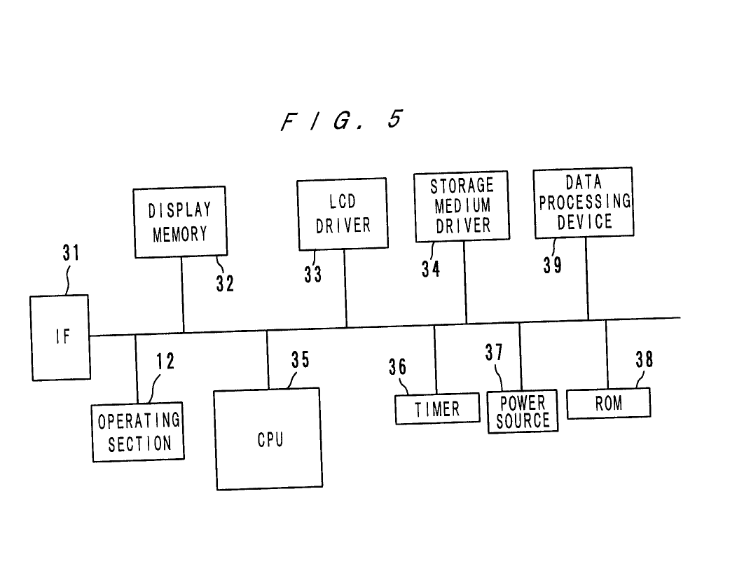

FIG. 5 shows a principal part of a control section of the sending terminal device 1. This control section comprises an interface 31 (for example, based on the standard USB, IEEE1394, Bluetooth MDL or the like) for connecting the terminal device 1 to the network 3, a display memory 32 for permitting a display of documents on the liquid crystal display 11, a driver 33 for driving the liquid crystal display 11, a driver 34 for driving a storage medium stored with documents, a CPU 35 for controlling the operating section 12 shown by FIG. 3 and the terminal device 1 totally, a timer 36 for setting the time to send documents, a power source 37 for supplying electric power to the whole of the terminal device 1, a ROM 38 stored with various kinds of data and programs, and a data processing device 39 for carrying out various kinds of data processing such as data expansion, data reduction, etc.

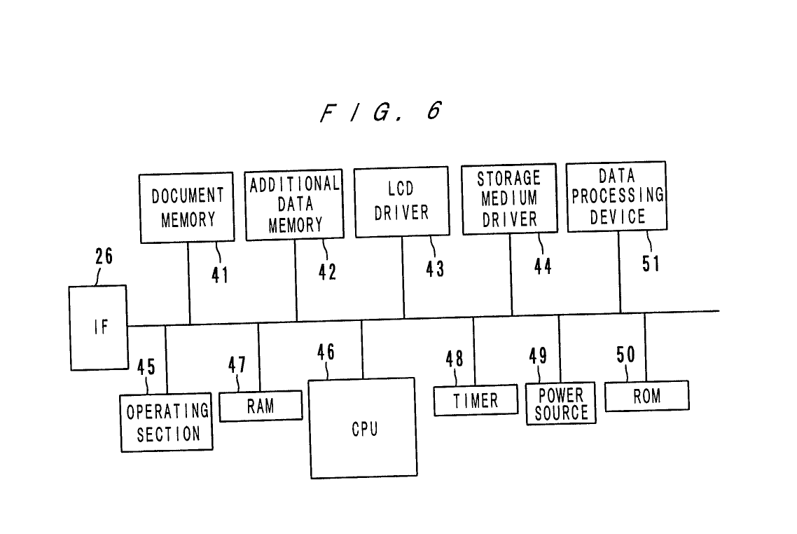

FIG. 6 shows a principle part of a control section of the receiving terminal device 2. This control section comprises an interface 26 (for example, based on the standard USB, IEEE1394, Bluetooth MDL or the like) for connecting the terminal device 2 to the network 3, a document memory 41 for permitting a display of documents on the liquid crystal display 21, an additional data memory 42 for permitting a display of data written through the touch panel 140 on the liquid crystal display 21, a driver 43 for driving the liquid crystal display 21, a driver 44 for driving the storage medium 25, an operating section 45 comprising the switch 22, the stylus pen 27, the touch panel 140, etc., a CPU 46 for controlling the terminal device 2 totally, a RAM 47 for storing tag information with respect to prohibition of deletion of documents (protect data, the time of receiving documents), a timer 48 for counting the time, a power source 49 for supplying electric power to the whole of the terminal device 2, a ROM 50 stored with various kinds of data and programs, and a data processing device 51 for carrying out various kinds of data processing such as data expansion, data reduction, etc.

### Liquid Crystal Display

Next, the liquid crystal display which uses liquid crystal which exhibits a cholesteric phase, and the touch panel are described.

FIG. 7 shows an exemplary reflective type liquid crystal display. In this liquid crystal display 21, on a light absorbing layer 121 provided on a rigid support plate 130 for preventing a bend, a red display layer 111R, a green display layer 111G and a blue display layer 111B are laminated. The red display layer 111R makes a display by switching between a red selective reflection state and a transparent state. The green display layer 111G makes a display by switching between a green selective reflection state and a transparent state. The blue display layer 111B makes a display by switching between a blue selective reflection state and a transparent state.

The touch panel 140 is provided on the liquid crystal display 21 with a preventive layer 148 in-between. The preventive layer 148 is to prevent pressure from being applied to part of the liquid crystal display 21. The touch panel 140 is of a well-known structure. On the surfaces of transparent substrates 141 and 142 which face each other, strip-like transparent electrodes 143 and 144 are provided, so that a matrix-type sensor is made. The substrates 141 and 142 are kept to have a specified gap in-between by spacer particles 146 and a sealant 147, and an air layer 145 is sealed in the gap. The intersection of the strip-like electrodes 143 and 144 are sensing sections, and these sensing sections correspond to the pixels of the display layers 111R, 111G and 111B.

Each of the display layers 111R, 111G and 111B has, between transparent substrates 112 on which transparent electrodes 113 and 114 are formed, resin columnar nodules 115, liquid crystal 116 and spacers 117. On the transparent electrodes 113 and 114, an insulating layer 118, an alignment controlling layer 119 are provided if necessary. Around the substrates 112 (out of a displaying area), a sealant 120 is provided to seal the liquid crystal 116 therein.

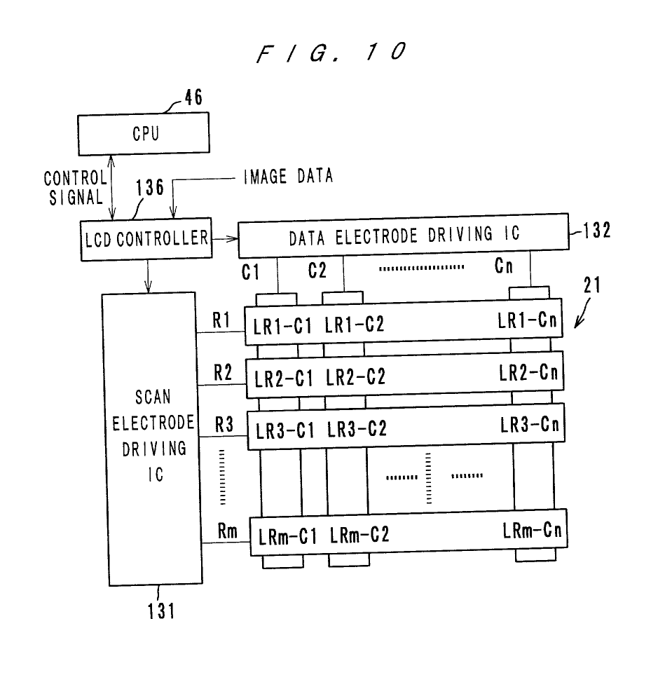

The transparent electrodes 113 and 114 are connected to driving ICs 131 and 132 respectively (see FIG. 10), and specified pulse voltages are applied between the transparent electrodes 113 and 114. In response to the voltages applied, the liquid crystal 116 switches between a transparent state to transmit visible light and a selective reflection state to selectively reflect light of a specified wavelength.

In each of the display layers 111R, 111G and 111B, the transparent electrodes 113 and 114, respectively, are composed of a plurality of strip-like electrodes which are arranged in parallel at fine intervals. The extending direction of the strip-like electrodes 113 and the extending direction of the strip-like electrodes 114 are perpendicular to each other, and the electrodes 113 and the electrodes 114 face each other. Electric power is applied between these upper electrodes and lower electrodes serially, that is, voltages are applied to the liquid crystal 116 serially in a matrix, so that the liquid crystal 116 makes a display. This is referred to as matrix driving. By carrying out this matrix driving toward the display layers 111R, 111G and 111B serially or simultaneously, a full-color image is displayed on the liquid crystal display 21.

A liquid crystal display which has liquid crystal which exhibits a cholesteric phase between two substrates makes a display by switching the liquid crystal between a planar state and a focal-conic state. When the liquid crystal is in the planar state, the liquid crystal selectively reflects light of a wavelength λ=Pn (P: helical pitch of the cholesteric liquid crystal, n: average refractive index). When the liquid crystal display is in the focal-conic state, if the wavelength of light selectively reflected by the liquid crystal is in the infrared spectrum, the liquid crystal scatters light, and if the wavelength of light selectively reflected by the liquid crystal is shorter than the infrared spectrum, the liquid crystal transmits visible light. Accordingly, if the wavelength of light selectively reflected by the liquid crystal is set within the visible spectrum and if a light absorbing layer is provided in the side opposite the observing side of the display, the liquid crystal display makes displays as follows: when the liquid crystal is in the planar state, the liquid crystal display makes a display of the color determined by the selectively reflected light; and when the liquid crystal is in the focal-conic state, the liquid crystal display makes a display of black. Also, if the wavelength of light selectively reflected by the liquid crystal is set within the infrared spectrum and if a light absorbing layer is provided in the side opposite the observing side of the display, the liquid crystal display makes displays as follows: when the liquid crystal is in the planar state, the liquid crystal reflects infrared light but transmits visible light, and accordingly, the liquid crystal display makes a display of black; and when the liquid crystal display is in the focal-conic state, the liquid crystal scatters light, and accordingly, the liquid crystal display makes a display of white.

In the liquid crystal display 21 in which the display layers 111R, 111G and 111B are laminated, when the liquid crystal of the blue display layer 111B and the liquid crystal of the green display layer 111G are in the focal-conic state (transparent state) and when the liquid crystal of the red display layer 111R is in the planar state (selective reflection state), a display of red is made. When the liquid crystal display of the blue display layer 111B is in the focal-conic state (transparent state) and when the liquid crystal of the green display layer 111G and the liquid crystal of the red display layer 111R are in the planar state (selective reflection state), a display of yellow is made. Thus, by setting the display layers 111R, 111G and 111B in the transparent state or in the selective reflection state appropriately, displays of red, green, blue, white, cyan, magenta, yellow and black are possible. Further, by setting the display layers 111R, 111G and 111B in intermediate states, displays of intermediate colors are possible, and thus, the liquid crystal display 21 can be used as a full-color display.

As the transparent substrates 112, transparent glass plates and transparent resin films are usable.

As the transparent electrodes 113 and 114, transparent electrodes of ITO (indium tin oxide), metal electrodes such as aluminum, silicon, etc., and electrodes of photoconductive films such as amorphous silicon, BSO (bismuth silicon oxide), etc. are usable. The transparent electrodes 114 on the lowermost layer may be black electrodes so as to also function as a light absorber.

As the insulating layers 118, inorganic films such as silicon oxide, etc. and organic films such as polyimide resin, epoxy resin, etc. are usable so as to also function as a gas barrier layer. The insulating layers 118 prevent short-circuits among the substrates 112 and improve the reliability of the liquid crystal. As the alignment controlling layers 119, typically polyimide is used.

The liquid crystal 116 preferably exhibits a cholesteric phase at room temperature. Especially chiral nematic liquid crystal which is produced by adding a chiral agent to nematic liquid crystal is suited.

A chiral agent is an additive which, when it is added to nematic liquid crystal, twists molecules of the nematic liquid crystal. When a chiral agent is added to nematic liquid crystal, the liquid crystal molecules form a helical structure with uniform twist intervals, and thereby, the liquid crystal exhibits a cholesteric phase.

Chiral nematic liquid crystal has an advantage that the pitch of the helical structure can be changed by changing the concentration of the chiral agent, whereby the wavelength of light to be reflected by the liquid crystal can be controlled. Generally, as a term expressing the pitch of the helical structure of liquid crystal molecules, the term “helical pitch” which is defined as the distance between liquid crystal molecules which are located at an angle of 360 degrees to each other along the helical structure is used.

For the columnar nodules 115, for example, thermoplastic resin can be used. The material of the columnar nodules 115 is required to be softened by heat, to be hardened by cool, not to react chemically to the liquid crystal material used and to have appropriate elasticity.

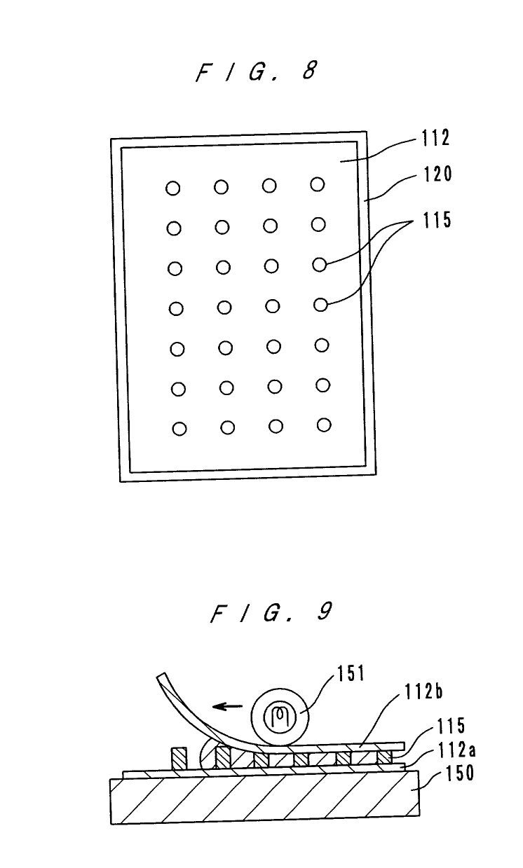

The columnar nodules 115 are formed by a conventional printing method. As FIG. 8 shows, the material is printed into dots by use of a pattern. The size of the sections, the arrangement pitch and the shape (cylinders, drums, square poles, etc.) of the nodules are determined depending on the size of the liquid crystal display 21 and the image resolution. It is preferred to arrange the columnar nodules 115 among the electrodes 113 so that the transmittance will be higher.

The spacers 117 are preferably particles of a rigid material which never be deformed by heat and/or pressure. For example, inorganic materials such as fine particles of glass fiber, balls of glass silicate, aluminum powder, etc. and particles of organic synthetic materials such as divinyl benzene bridged polymer, polystyrene bridged polymer, etc. are usable.

Thus, the rigid spacers 117 are provided between two substrates 112 to keep a specified gap in-between, and the resin nodules 115 made of a material mainly containing thermoplastic polymer are arranged in a specified pattern within the displaying area to support and bond the substrates 112. In the structure, the substrates 112 are entirely supported firmly, and alignment unevenness of the liquid crystal and occurrence of bubbles in the liquid crystal under low temperature can be prevented. The spacers 117 are not indispensable.

An exemplary method of producing the liquid crystal display 21 is briefly described.

On each of two transparent substrates, a plurality of transparent electrodes are formed. The transparent electrodes are formed by sputtering an ITO film and by patterning the ITO film by photolithography.

Next, transparent insulating layers and alignment controlling layers are formed on the transparent electrodes of the respective substrates. The insulating layers and the alignment controlling layers are formed of an inorganic material, e.g., silicon oxide or an organic material, e.g., polyimide resin by a conventional method such as sputtering, spin coating, roll coating or the like. The alignment controlling layers are not subjected to a rubbing treatment. Although the function of such alignment controlling layers is not clear, it is considered that alignment controlling layers provide liquid crystal molecules with an anchoring effect more or less, which results in preventing the liquid crystal display from changing in characteristics as time goes by. Also, a coloring agent may be added to these layers so that these layers will also function as color filters. Thereby, the color purity and the contrast can be improved.

On one of the substrates which have obtained the transparent electrodes, the insulating layers and the alignment controlling layers in this way, columnar nodules are formed on the surface with electrodes thereon. For the columnar nodules, paste of a resin material which is prepared by dissolving resin in a solvent is used. A printing method in which the resin paste is extruded by a squeegee via a screen, a metal mask or the like on the substrate placed on a planar stage, a dispenser method or an ink jet method in which the resin material is ejected onto the substrate from the end of a nozzle, and a transfer method in which the resin material is supplied to a plate or a roller and thereafter transferred onto the substrate can be adopted to form the resin nodules. The resin nodules, when they are formed, preferably have a height larger than the desired thickness of the display layer.

On the electrode surface of the other substrate, a sealant made of ultraviolet setting resin, thermosetting resin or the like is provided. The sealant is formed into an endless ring along the periphery of the substrate. To form the sealant, a dispenser method or an ink jet method in which the resin material is ejected from the end of a nozzle onto the substrate, a printing method using a screen, a metal mask or the like, and a transfer method in which the resin material is supplied to a plate or a roller and thereafter transferred onto the substrate can be adopted. Further, on at least one of the substrates, spacers are dispersed by a conventional method.

These two substrates are laminated together with the respective surfaces with electrodes thereon facing each other, and the laminate of substrates is heated while being pressed from both sides. The application of heat and pressure can be carried out, for example, in the way illustrated by FIG. 9. The substrate 112a with the columnar nodules 115 thereon is placed on a plate 150, and the other substrate 112b is placed on the substrate 112a. A heating/pressing roller 151 rolls over the substrate 112b from an end while heating and pressing the substrates 112a and 112b, that is, while the substrates 112a and 112b are passing through between the roller 151 and the plate 150 being pressed and heated, the substrates 112a and 112b are laminated together. In this way, even when elastic flexible substrates such as film type substrates are used, it is possible to fabricate a cell accurately. If the columnar nodules are made of thermoplastic polymer, the columnar nodules are softened by heat and hardened by cool, whereby the substrates can be bonded together by the columnar nodules. If the sealant is made of thermosetting resin, the sealant can be hardened by the heat during this laminating process.

In the laminating process, a liquid crystal material is dropped on one of the substrates, and the liquid crystal material is filled between the substrates while the substrates are laminated together. The liquid crystal material contains spacers, and the material is dropped on the electrode surface of at least one of the substrates.

The liquid crystal material is dropped on the substrates at an end, and the liquid crystal material is spread over to the other end while the roller is rolling over the substrates to laminate the substrates together. In this way, the liquid crystal material is filled in the whole area of the space between the substrates. By adopting this laminating method, it is possible to suppress intake of bubbles into the liquid crystal material in the laminating process.

Thereafter, the application of pressure to the substrates is continued until the temperature of the substrates falls down to at least the softening point of the resin material of the columnar nodules. Further, if the sealant is made of photosetting resin, radiation is carried out to harden the sealant.

In the same procedure, the blue display cell, the green display cell and the red display cell are fabricated while using different liquid crystal materials which selectively reflect light of mutually different wavelengths. These three cells are laminated and bonded together, and a light absorbing layer is provided on the bottom of the lowermost cell. Finally, a full-color liquid crystal display is fabricated.

The pixels are structured into a matrix which is composed of a plurality of scan electrodes R1, R2, . . . Rm and a plurality of data electrodes C1, C2, . . . Cn (n, m: natural numbers). The scan electrodes R1, R2 . . . Rm are connected to output terminals of a scan electrode driving IC 131, and the data electrodes C1, C2, . . . Cn are connected to output terminals of a data electrode driving IC 132.

The scan electrode driving IC 131 outputs a selective signal to a specified one of the scan electrodes R1, R2, . . . Rm while outputting a non-selective signal to the other scan electrodes R1, R2, . . . Rm. The scan electrode driving IC 131 outputs the selective signal to the scan electrodes R1, R2, . . . Rm one by one at specified time intervals. In the meantime, the data electrode driving IC 132 outputs signals to the data electrodes C1, C2, . . . Cn simultaneously in accordance with image data to write the pixels on the selected scan electrode. For example, while a scan electrode Ra (a≦m, a: natural number) is selected, the pixels LRa-C1 through LRa-Cn on the intersections of the scan electrode Ra and the data electrodes C1, C2, . . . Cn are written simultaneously. In each pixel, the voltage difference between the scan electrode and the data electrode is a voltage for writing the pixel (writing voltage), and each pixel is written in accordance with this writing voltage.

The driver 43 of the liquid crystal display 21 comprises an LCD controller 136 and the driving ICs 131 and 132. In accordance with image data stored in the memories 41 and 42, the LCD controller 136 controls the driving ICs 131 and 132. Thereby, voltages are applied between the scan electrodes and the data electrodes of the liquid crystal display 21 serially, so that an image is written on the liquid crystal display 21.

Suppose the threshold voltage (first threshold voltage) to untwist liquid crystal which exhibits a cholesteric phase to be Vth1, when the first threshold voltage Vth1 is applied to the liquid crystal for a sufficiently long time and thereafter, the voltage is lowered under a second threshold voltage Vth2 which is lower than Vth1, the liquid crystal comes to a planar state. When a voltage which is higher than Vth2 and lower than Vth1 is applied to the liquid crystal for a sufficiently long time, the liquid crystal comes to a focal-conic state. These two states are maintained even after stoppage of application of voltage. Also, by applying voltages between Vth1 and Vth2 to the liquid crystal, it is possible to display intermediate tones, that is, gray levels.

Further, when writing part of the liquid crystal display 21, only specified scan electrodes including the part shall be selected. In this way, writing is carried out on only necessary part of the liquid crystal display, which requires a shorter time.

Writing can be carried out in the above-described way. If an image is displayed on the liquid crystal display, preferably, all the pixels are reset to the same state before writing a new image so that the newly written image will not be influenced by the previously displayed image. The reset of all the pixels may be carried out simultaneously or may be serially by scan electrode. It is known that it takes a comparatively long time to reset a pixel to a focal-conic state or to be sufficiently transparent. Therefore, resetting all the pixels to a focal-conic state simultaneously is preferable to resetting the pixels by scan electrode because it takes a shorter time.

When writing is to be carried out on part of the liquid crystal display, the reset may be carried out by scan electrode, or the pixels on specified scan electrodes including the desired part may be reset at one time.

The above-described liquid crystal display 21 has resin columnar nodules in the displaying area. This structure permits fabrication of a liquid crystal display which is light and which is excellent in display performance by use of film type substrates. This structure also permits easy fabrication of a large-scale liquid crystal display and fabrication of a liquid crystal display which requires a relatively low driving voltage, which is strong against shock and which has various other advantages.

However, the liquid crystal display with a memory effect is not necessarily of this structure. It is possible to structure the liquid crystal display layer to be a polymer-dispersed type composite layer in which a three-dimensional polymer net is formed in liquid crystal. Also, as the liquid crystal with a memory effect, not only bistable liquid crystal which exhibits a cholesteric phase but also other kinds of liquid crystal with a memory effect, for example, ferroelectric polymer liquid crystal and ferroelectric liquid crystal can be used.

### Operation of System

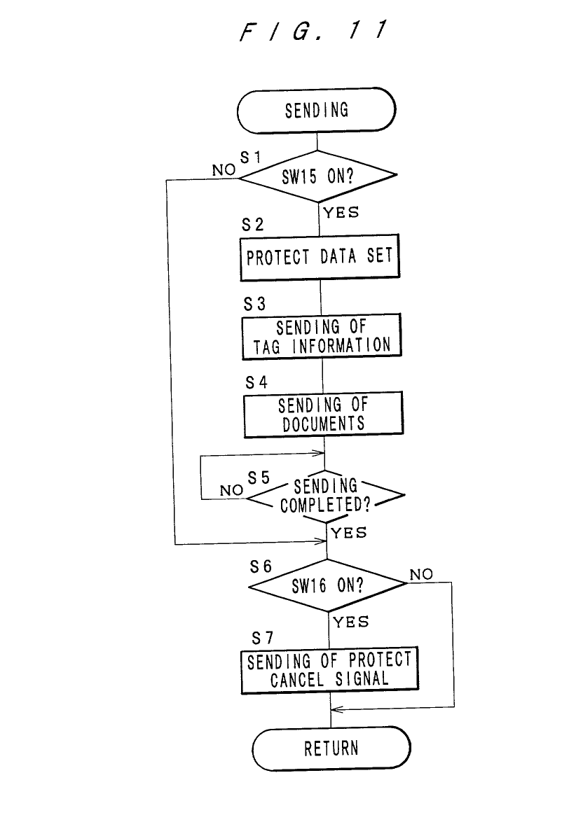

Next, referring to the flowcharts of FIG. 11 through FIG. 19, operation of the sending terminal device 1 and the receiving terminal device 2 are described.

FIG. 11 through 14 show respectively a first example, a second example, a third example and a fourth example of a control procedure of the sending terminal device 1. In these examples, when documents are sent from the sending terminal device 1 to the receiving terminal device 2, protect data are set to prevent deletion of the documents in the receiving terminal device 2, and cancellation of the protect data is possible.

In the first example shown by FIG. 11, first, when the send switch is turned on (“YES” at step S1), protect data are set for the documents to be sent at step S2. These protect data are sent to the receiving terminal device 2 separately from the documents as another file together with information on the number of pages, etc. (step S3). Then, the documents are sent at step 4.

Thereafter, when the sending of the documents and the protect data is completed (“YES” at step S5) or when the switch 15 is not turned on (“NO” at step S1), it is judged at step S6 whether or not the protect cancel switch 16 is turned on. If the cancel switch 16 is off, this routine is terminated. If the switch 16 is on, a protect cancel signal is sent to the receiving terminal device 2 at step S7. Then, the program is returned.

In the second example shown by FIG. 12, when the power switch 14 of the sending terminal device 1 is turned off (“YES” at step S6′), the protect cancel signal is sent to the receiving terminal device 2 at step S7, and then, the CPU 35 completes this routine. When the power switch 14 is not turned off (“NO” at step S6′), the program returns. At the other steps S1 through S5, the same processes as in the first example shown by FIG. 11 are carried out.

In this second example, when the power of the sending terminal device 1 is turned off, the protect cancel signal is automatically sent to the receiving terminal device 2. Therefore, in the second example, the protect cancel switch 16 is omitted. The switch 16 may be provided, and in this case, when “NO” at step S6′, the processes at steps S6 and S7 in FIG. 11 shall be carried out.

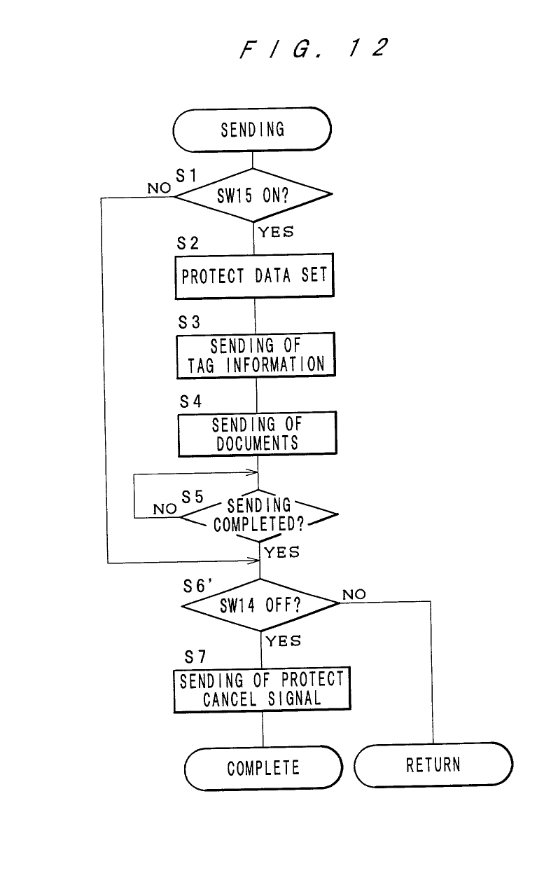

In the third example shown by FIG. 13, when the send switch 15 is turned on (“YES” at step S1), sending time data are set at step S2′, and the sending time data are sent to the receiving terminal device 2 as tag information at step S3. Then, the documents are sent at step S4. When the sending of the tag information and the documents is completed (“YES” at step S5), this routine is completed, and the program returns. When the send switch 15 is not turned on (“NO” at step S1), the program returns immediately.

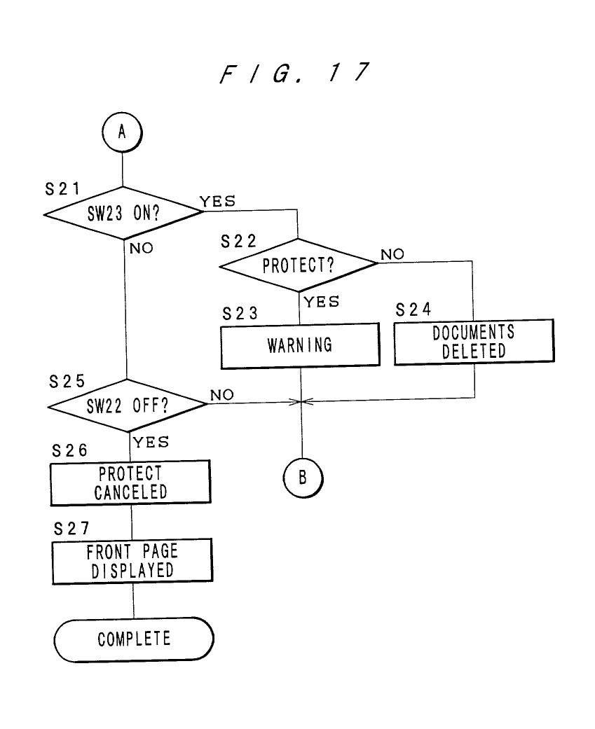

In this third example, the sending time data are sent to the receiving terminal device 2, and the receiving terminal device 2 has a program to prohibit deletion of the documents until a specified time a (the duration of the conference, for example, two hours, four hours or one day) passes and to permit deletion of the documents after passing of the time α (see FIG. 18). Therefore, in the third example, protect data are not set.

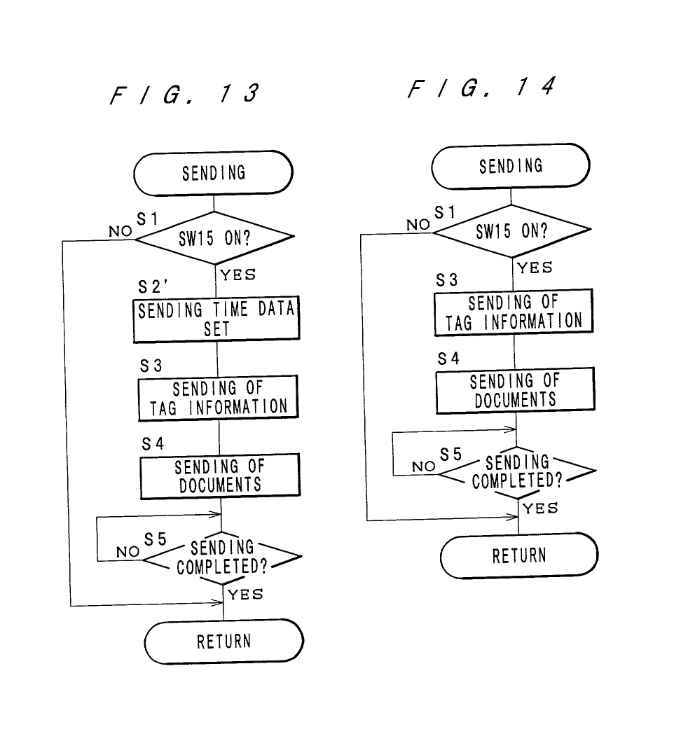

The fourth example shown by FIG. 14 is adopted in the second embodiment shown by FIG. 2. In the fourth example, protect data are set by the adapter 4, and cancellation of the protect is set in the receiving terminal device 2 (See FIG. 19). In the fourth example, when the send switch 15 is turned on (“YES” at step S1), tag information and documents is sent to the receiving terminal device 2 at steps S3 and S4. When the sending of these data is completed (“YES” at step S5), this routine is completed, and the program returns. When the send switch 15 is not turned on (“NO” at step S1), the program returns immediately.

In the first through fourth examples, the protect data and/or the sending time data may be made and sent to be attached to the whole documents or may be made and sent to be attached to each page of the documents.

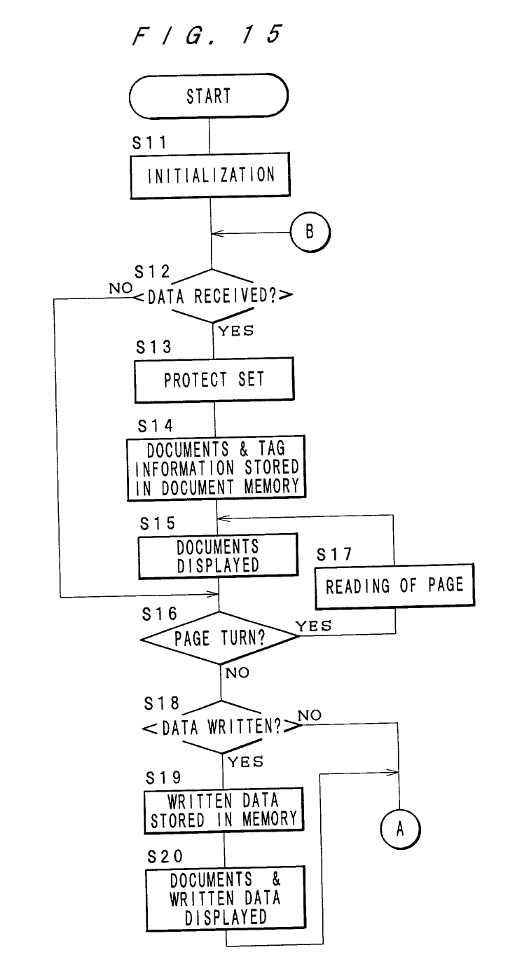

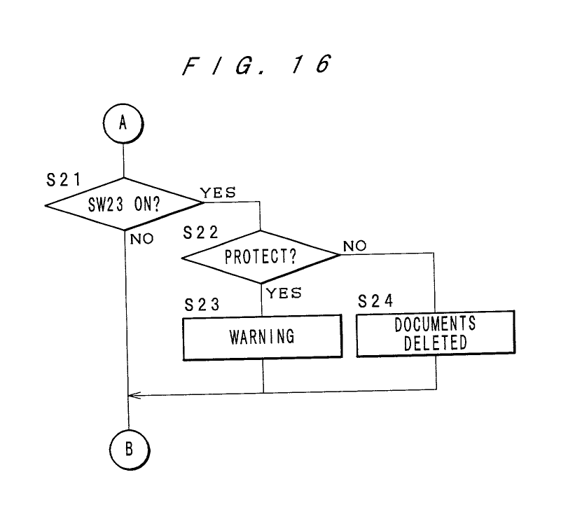

FIGS. 15 through 19 show examples of a control procedure of the receiving terminal device 2. FIGS. 15 and 16 show a first example which agrees with the first example and the second example of the control procedure of the sending terminal device 1. FIG. 17 shows a second example which agrees with the first example and the second example of the control procedure of the sending terminal device 1. FIG. 18 shows a third example which agrees with the third example of the control procedure of the sending terminal device 1. FIG. 19 shows a fourth example which agrees with the fourth example of the control procedure of the sending terminal device 1.

In the first example shown by FIG. 15 and 16, when the power of the receiving terminal device 2 is turned on, the program starts. First, initialization by the CPU 46, including clearance of the memory 42, reset of hard circuits such as clearance of the RAM 47 and reset of various flags, is carried out at step S11.

Next, it is judged at step S12 whether or not data have been received from the sending terminal device 1. When data are received (“YES” at step S12), a protect setting process is carried out at step S13. More specifically, if the data received include protect data, the protect data are stored in the RAM 47 so that the documents protected by the protect data cannot be deleted. On the other hand, if the data received include a protect cancel signal, the protect data are deleted from the RAM 47. If the data received include neither protect data nor a protect cancel signal, no particular processes are carried out at step S13.

Next, if the data received include documents and tag information, these data are stored in the document memory 41 at step S14, and the data are displayed on the liquid crystal display 21. If the data received include neither documents nor tag information, no particular processes are carried out at step S14 and S15.

Next, when a page turn (forward or backward) is commanded with the switch 24 (“YES” at step S16), data of the designated page are read out of the memory 41 at step S17, and the data are displayed at step S15.

Also, when some information is written on the touch panel 140 with the stylus pen 27 (“YES” at step S18), the written data are stored in the memory 42 at step S19, and the data are additionally displayed on the liquid crystal display 21 at step S20. The way of inputting data by use of the touch panel 140 and the way of displaying the data additionally to the documents are well known, and the description is omitted.

Next, when the delete switch 23 is turned on (“YES” at step S21), it is judged at step S22 whether or not the documents just received are protected not to be deleted by protect data based on the contents of the RAM 47. If the data are protected, a warning to indicate the prohibition of deletion is made at step S23, and thereafter, the program goes back to step S12 in FIG. 15. If the protection has been cancelled, the documents are deleted from the memory 41 at step S24, and the program goes back to step S12.

On the other hand, when the delete switch 23 is not turned on (“NO” at step S21), the program goes back to step S21 in FIG. 15 immediately.

Next, the second example shown by FIG. 17 is described. When the receiving terminal device 2 receives documents and tag information, the same processes as at step S11 through S20 shown in FIG. 15 are carried out. When the delete switch 23 is turned on, at steps S21 through S24, the same processes as in the first example shown by FIG. 15 are carried out.

In the second example, when the power switch 22 is turned off (“YES” at step S25), the protection of the documents is canceled at step S26, that is, the protect data are deleted from the RAM 47. Then, the front page of the documents just received by the terminal device 2 is displayed on the liquid crystal display 21 at step S27, and the CPU 46 completes the routine.

In the second example, when the receiving terminal device 2 is turned on again, the protect data of the documents previously received have been already deleted, and therefore, the documents previously received can be deleted.

The liquid crystal display 21 of the receiving terminal device 2 has a memory effect and therefore can keep displaying an image even after stoppage of supply of electric power. Generally, the title of the conference, etc. are listed on the front page of the documents, and by displaying the front page, the user can recognize what the conference was about. The page to be displayed at the time of power off is not necessarily the front page, and any page shall be displayed as long as the page provides the user with information about the conference. Also, when the documents are deleted, no displays may be made on the liquid crystal display 21, or only the front page may be left in the memory 41 and may be displayed on the liquid crystal display 21.

Next, the third example shown by FIG. 18 is described. The third example agrees with the third example of the control procedure of the sending terminal device 1 in which documents are protected based on sending time data. Therefore, instead of storing protect data in the RAM 47 as is carried out at step S13 in FIG. 15, sending time data are stored in the RAM 47 at step S13′. When the receiving terminal device 2 receives documents and tag information, the same processes as in the first example, that is, the processes at steps S11 through S20 shown in FIG. 15 are carried out except replacing the step S13 with the step S13′.

When the delete switch 23 is turned on (“YES” at step S41), it is judged at step S42 whether or not the specified time α has passed since the sending time stored in the RAM 47. If the time α has not passed, a warning to indicate the prohibition of the deletion is made at step S43. If the time α has passed, the documents are deleted from the memory 41 at step S44. Then, the program goes back to step S12 in FIG. 15.

In the third example, without making any particular operations such as receiving of a protect cancel signal, turning-off of the power switch 22, etc., deletion of the documents is automatically permitted after passing of the specified time α.

Next, the fourth example shown by FIG. 19 is described. The fourth example is to be adopted in the second embodiment which uses an adapter 4 and agrees with the fourth example of the control procedure of the sending terminal device 1. In the fourth example, when the receiving terminal device 2 receives documents and tag information, the same processes as in the first example, that is, the processes at steps S11through S20 shown in FIG. 15 are carried out. Also, when the delete switch 23 is turned on, the same processes as in the first example, that is, the processes at steps S21 through S24 in FIG. 16 are carried out.

In this fourth example, when the receiving terminal device 2 is disconnected from the network 3 by shutting the connection to the adapter 4 (“YES” at step S47), protection of documents is cancelled, that is, protect data are deleted from the RAM 47 at step S48. Thereafter, the front page of the documents just received by the terminal device 2 is displayed on the liquid crystal display 21 at step S49, and the program goes back to step S12 in FIG. 15. The purpose of displaying the front page is the same as that in the second example.

Disconnection of the receiving terminal device 2 from the network 3 can be regarded as completion of a conference. Accordingly, deletion of the documents is permitted thereafter.

### General Structure of Electronic Conference System

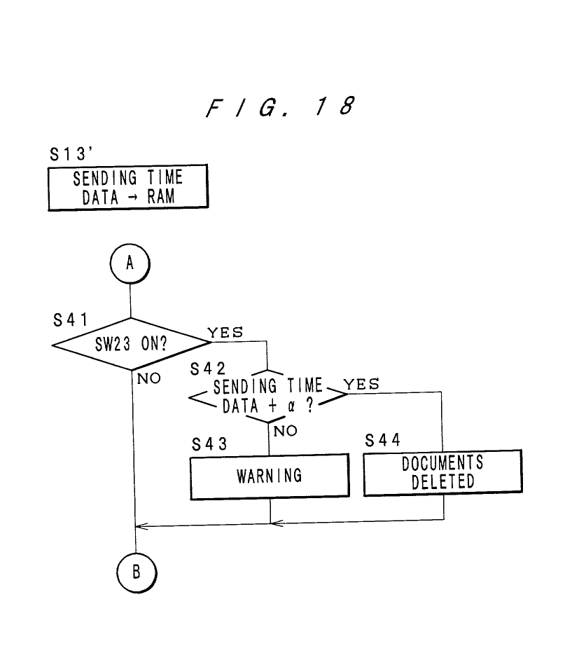

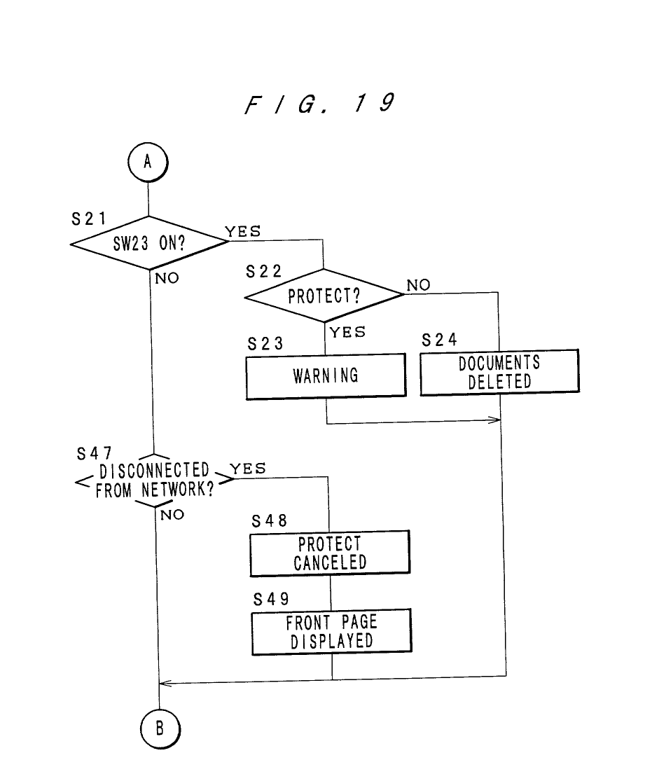

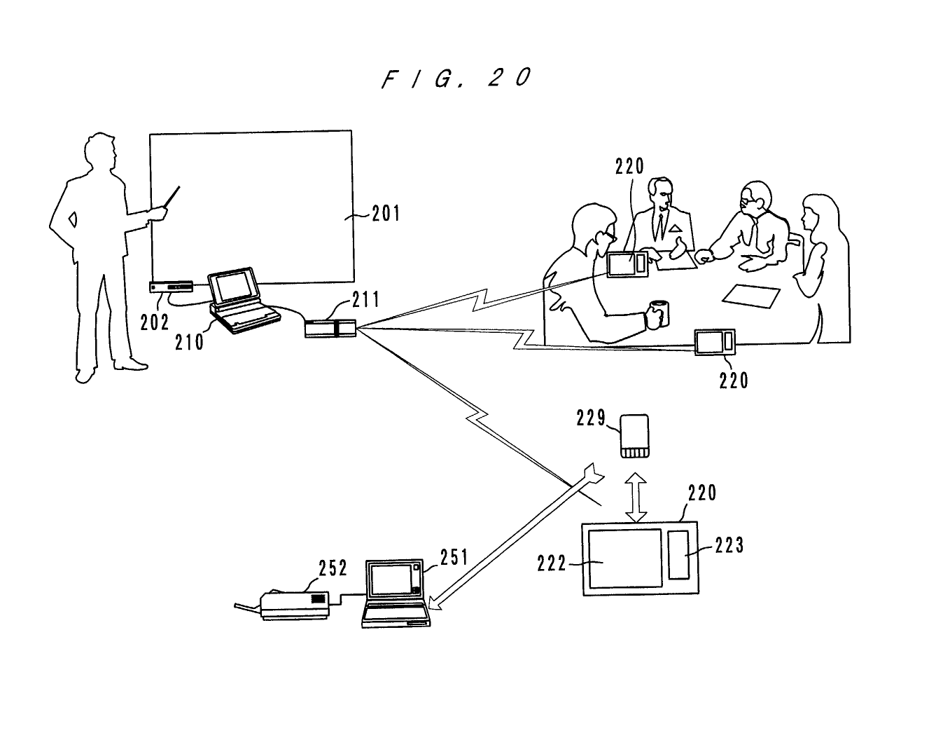

FIG. 20 shows the general structure of an electronic conference system. This system generally comprises a large-scale host display device 201 for presentation, an electronic document server 210 which functions as a host device, and a plurality of display devices 220. The host display device 201 and the server 210 are used by the host of the conference, and the display devices are used by the participants.

The server 210 has a display panel, on which information displayed on the host display device 201 is displayed. The host display device 201 is effective for presentation but is not always necessary. Since the server 210 itself has a display panel, it is recognizable which part of the documents the host designates.

The host display device 210 has a display panel (see FIG. 7) which uses liquid crystal which exhibits a cholesteric phase at room temperature, for example, chiral nematic liquid crystal. The host display device 201 comprises an operation panel for commanding a page turn and initialization of the screen, and an operating/driving unit 202 including a driving circuit of the display panel, and the host display device 201 can be controlled by the electronic document server 210. The electronic document server 210 has a communication module 211 and distributes electronic documents to the display devices 220 via radio waves or the like.

The communication module 211 may be separated from the server 210, for example, may be a PHS, a portable telephone or the like, or may be incorporated in the server 210. Also, the server 210 and each of the display devices 220 may be connected to each other via a cable. Further, the host display device 201 may be a display device which does not use liquid crystal.

### Structure of Display Device

As FIG. 21 shows, the display device 220 has, in a casing 221, a display panel 222 which displays electronic information, an operating section 223 which receives inputs from an operator, a communicator 224 which exchanges data with the electronic document server 210, and a driver which drives a storage medium to be stored with information received (a port 225 through which the storage medium is inserted in and taken out of the display device 220 is shown in FIG. 21).

The display panel 222 is a liquid crystal display and is of a size almost equal to A4 size. This size is compatible with documents which are usually used in offices; however, the display panel 222 may not be of this size.

By using a liquid crystal display as the display panel 222, the whole display device 220 can be made thin and compact. There are various possible ways of driving liquid crystal displays. Especially, when using liquid crystal with a memory effect, such as cholesteric liquid crystal, chiral nematic liquid crystal, ferroelectric liquid crystal, ferroelectric polymer liquid crystal, etc., the display panel 222 can continue displaying information thereon although cannot write new information thereon even after supply of electric power thereto is stopped. Accordingly, using such liquid crystal contributes to energy saving.

Thus, a display which uses liquid crystal with a memory effect is very suited to be used as the display device 220 which is employed in an electronic conference system to display documents. For example, even if a long-time presentation or discussion is made referring to one page of the documents, the display consumes no electric power to keep displaying the page.

Especially if cholesteric liquid crystal or chiral nematic liquid crystal is used, for example, when liquid crystal layers which selectively reflect RGB respectively are laminated, full-color display becomes possible, and expressive display can be achieved. Further, neither a polarizing plate nor a back light is necessary, and a handy display device of a simple structure, that is, a display device the user can hold by hand to see the image displayed thereon, can be achieved.

As the display panel 222, not only a liquid crystal display but also a luminescence display and a plasma display can be used. If either of these displays is used, the whole device can be made thin.

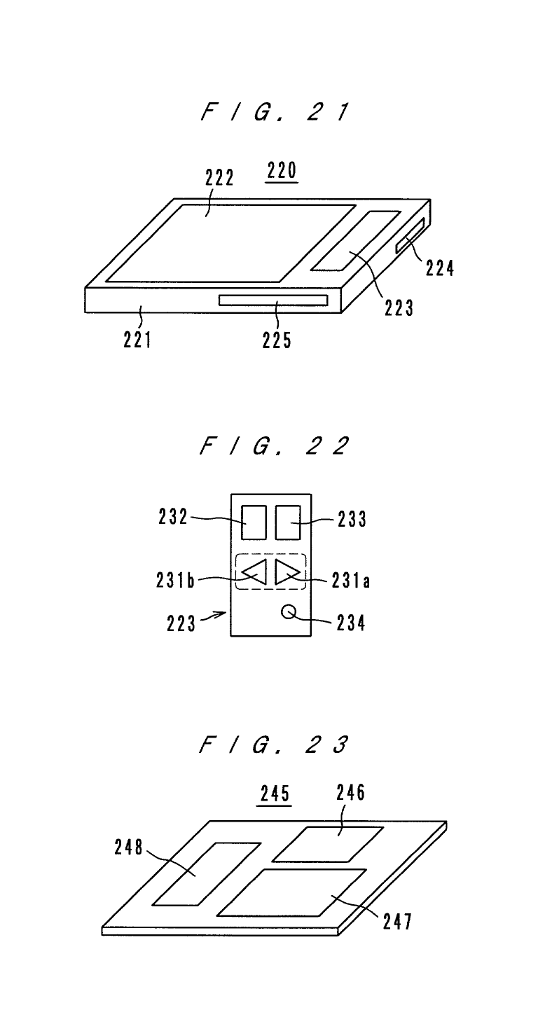

As FIG. 22 shows, there are provided in the operating section 223, a screen key (composed of a forward key 231a and a rewind key 231b), a host display position indicator 232 which displays information about the image displayed on the display panel of the host display device 201 or the server 210 (information about the page designated by the host), a current display position indicator 234 which displays information about the image displayed on the display device 220 (information about the currently displayed page) and a store key 234 which commands storage of information in the memory card 229 (see FIG. 20) inserted in the port 225.

What is displayed on the host display position indicator 232 is information about the image displayed on the display panel of the host display device 201 or the server 210, for example, the positional information about the image which is a part of documents composed of a plurality of pages (page number or the like), and this information is sent from the server 210. On the contrary, the display device 220 monitors the image which the server 210 displays on the host display device 201 and indicates data about the image on the host display position indicator 232.

What is displayed on the current display position indicator 233 is information about the image displayed on the display panel 222, for example, the positional information about the image which is a part of documents composed of a plurality of pages (page number or the like). The positional information about the image displayed on the display panel of the server 210 or the host display device 201 is hereinafter referred to as host display positional information, and the positional information about the image displayed on the display panel 222 of the display device 220 is hereinafter referred to as current display positional information. These indicators 232 and 233 are liquid crystal displays; however, they may be of any other type.

The communicator 224 is an interface connector to which a wireless modem such as a PHS, a portable telephone or the like is to be connected, or a card slot in which a data sending/receiving card to which a wireless modem such as a PHS, a portable telephone or the like is to be connected or a data sending/receiving card incorporating a wireless modem is to be inserted. Off course, the communicator 224 may be wireless communication means such as IrDA.

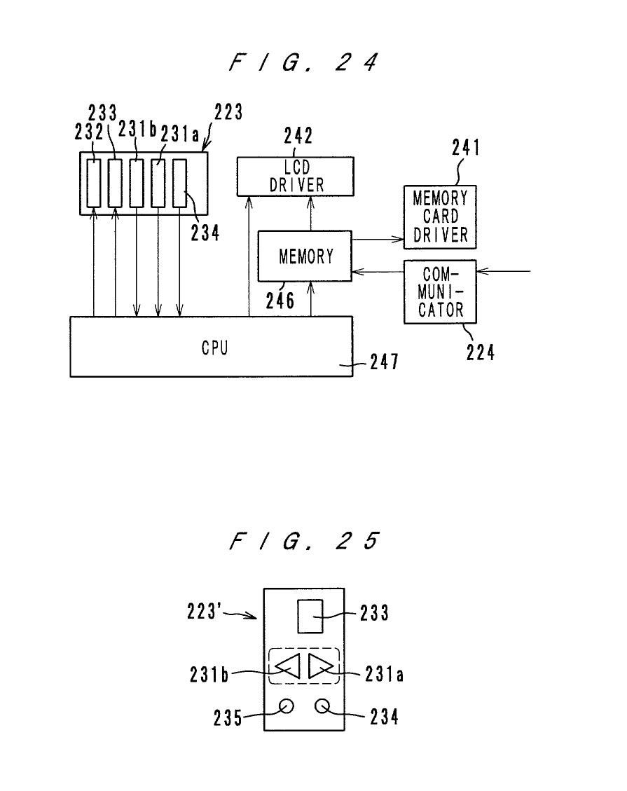

In the casing 221, a driver 241 ( see FIG. 24) which carries out writing and reading of image data into and from a storage medium inserted in the storage medium port 225 is provided. In accordance with the command made with the store key 234, the driver 241 stores information in the storage medium. As the storage medium, not only the memory card 229 shown in FIG. 20 but also a floppy disk, a hard disk, an optical disk and other various kinds are usable.

These storage media can be inserted in a note type computer 251, and the information can be printed out by a printer 252 connected to the computer 251.

FIG. 23 shows a schematic view of a control board 245 incorporated in the display device 220, and FIG. 24 shows a control section. On the control board 245, a memory 246, a CPU 247 and a power source 248 which supplies electric power to every part of the display device 220 are mounted. The memory 246 stores information sent from the server 210 through the communicator 224 by order of the CPU 247. The CPU 247 controls the operation of every part of the display device 220 totally and functions as a monitor in cooperation with the communicator 224 to check whether or not there has been sending of information from the server 210 indicating that the server 210 has turned a page. The CPU 247 may be so structured to read display positional information of the server 210 at specified time intervals (short intervals) to monitor a page turn of the server 210.

The information stored in the memory 246 is transmitted to the driver 242 of the display panel 222 and is displayed on the display panel 222 in accordance with a control signal outputted from the CPU 247. The memory 246 is further capable of transmitting data to the storage medium driver 241.

### Application of Electronic Conference System and

### Operation of Display Devices

Next, application of the electronic conference system including operation of the display devices 220 is described.

When the electronic document server 210 and the display devices 220 are turned on at the start of an electronic conference, the server 210 comes to a state to be capable of transmitting information to the display devices 220 via wireless communication means or a cable. In this state, the host displays electronic information which is documents for the conference and which is stored in the server 210 on the host display device 201 and simultaneously sends the information from the server 210 to the display devices 220.

The information is received by each of the display devices 220 through the communicator 224 and is stored in the memory 246. The volume of information differs from conference to conference, and the memory 246 has a sufficiently large capacity.

Described in the following is a case in which all the documents for the conference are sent from the server 210 to the display devices 220 at one time beforehand; however, the server 210 may be so controlled to send data to be newly displayed every time of turning a page.

A page turn of the server 210 can be carried out by key operation or the like. The server 210 is capable of transmitting not only the documents for the conference but also tag information including display positional information.

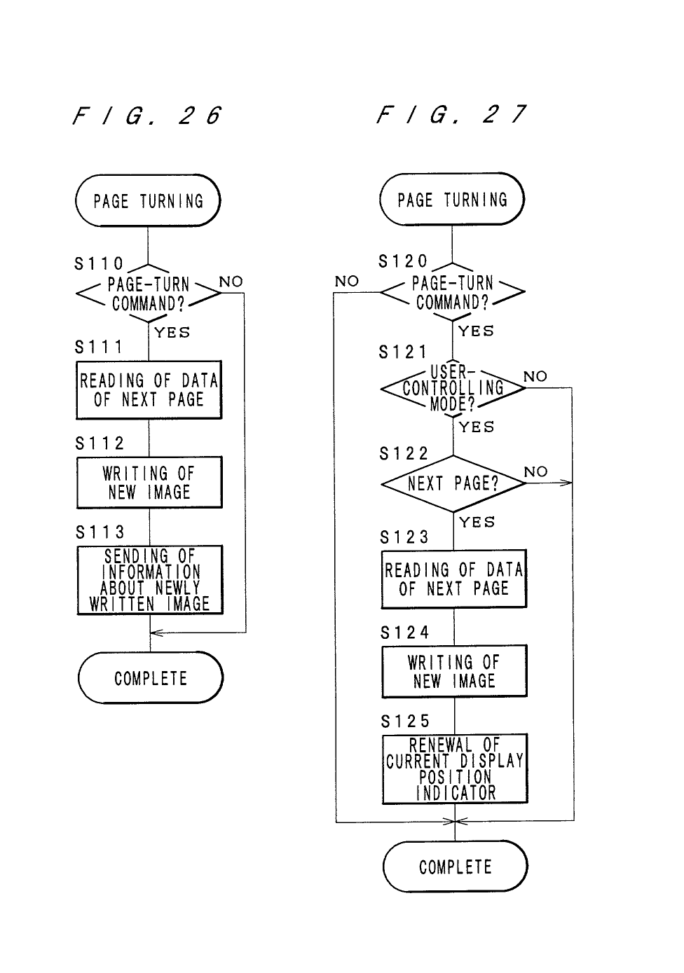

FIG. 26 is a flowchart which shows a page turning procedure carried out by the server 210. When the server 210 confirms a page-turn command by use of a key (“YES” at step S110), the server 210 reads data of the next page from the storage medium into the memory at step S111 and writes a new image on the host display device 201 in accordance with the data of the next page at step S112. Then, the server 210 sends information about the newly displayed page from the communication module 211 at step S113, and this routine is completed.

As will be described later, based on the page data sent from the server 210, each of the display devices 220 monitors writing of a new image on the host display device 201 and the position of the image.

Next, the procedure of the participants to get the information is described. With respect to this procedure, there are a first mode in which the host has control and a second mode in which the participants have control. The first mode and the second mode can be switched by use of keys of the server 210, and the host can set either of the modes beforehand. It may be possible to switch the mode in the middle of the conference. Also, the participants may switch the mode.

In the first mode, information is sent one way from the server 210 controlled by the host to the display devices 220 of the participants. In this case, the participants do not need to operate the respective display devices 220 at all. In other words, the display devices 220 only display information sent from the server 210. This first mode is hereinafter referred to as a host-controlling mode. Therefore, in the host-controlling mode, the display devices 220 display the same image as that on the display panel of the server 210 or on the host display device 201.

In the second mode, the participants have control. After the host sends information from the server 210 to the display devices 220 of the participants, the participants operate the respective display devices 220, and the participants can display any desirable information on the respective display panels 222 independently of the image displayed on the display panel of the server 210 or on the host display device 201. This second mode is hereinafter referred to as a user-controlling mode.

Referring to the flowcharts of FIGS. 27, 28 and 29, control procedures of the display device 220 in these modes are described.

FIG. 27 is a flowchart which shows a page turning procedure carried out by the display device 220. When a page-turn command is made by use of the key 231a or 231b (“YES” at step S120), it is judged at step S121 whether or not the user-controlling mode is set. If “YES” at step S121 and when there is a next page (“YES” at step S122), data of the next page are read in the memory at step S123, and the next page is displayed at step S124. Then, the current display position indicator 233 is renewed at step S125, and this routine is completed. On the other hand, if the host-controlling mode is set (“NO” at step S121), this routine is terminated immediately, so that the page-turn command is inhibited. In this way, the usr-controlling mode permits the user to see any desirable page, and the host-controlling mode prohibits the user from seeing desirable pages.

According to the procedure, the current display position indicator 233 displays positional information (e.g. page number) about the image displayed on the display panel 222, and the current display position indicator 233 is renewed every time the display panel 222 displays a new image.

In the meantime, each of the display devices 220 is monitoring the image displayed on the host display device 201 or the display panel of the server 210 and displays the result on the host display position indicator 232. Thereby, even if the user of the display device 220 changes the page displayed thereon by use of the keys 231a and 231b, the user can recognize the difference between the image on the host display device 201 and the image on the display device 220 by comparing the host display position indicator 232 with the current display position indicator 233. Then, the participant can return the display device 220 to the page designated by the host immediately by use of the keys 231a and 231b.

FIG. 28 is a flowchart which shows a host display position monitoring procedure carried out by the display device 220. When host display positional information is sent from the server 210 (“YES” at step S130), it is judged that the server 210 has turned a page. Accordingly, at step S131, the stored positional information is updated to be consistent with the host display positional information received, and at step S132, the host display position indicator 232 is renewed. If the host-controlling mode is set at this time (“YES” at step S133), an image indicated by the host display positional information is newly written on the display device 220 at step S134, and the current display position indicator 233 is renewed accordingly at step S135. Then, this procedure is completed. In this way, in response to a page-turn of the server 210, the display on the display device 220 is automatically changed. On the other hand, if the user-controlling mode is set (“NO” at step S133), this procedure is terminated without changing the display on the display device 220.

Further, in order to return the display device 220 to the page displayed on the display panel of the server 210 or on the host display device 201 (host display position) immediately even if the host display position is far from the page displayed on the display device 220 (current display position), a key to designate a page number directly (e.g., a ten-key) or a jump key to jump to the host display position may be provided.

In this embodiment, there are two indicators 232 and 233 in a display position indicating section; however, the display position indicating section may be so structured that there is only one indicator and that indication of the host display position and indication of the current display position can be switched by use of a switch key. The display position indicating section can be of any structure as long as it permits the user to recognize the difference between the host display position and the current display position.

### Another Example of Operating Section

FIG. 25 shows another exemplary operating section. This operating section 223′ has a return key 235 instead of the host display position indicator 232. The other members are the same as those of the operating section 223 shown by FIG. 22, and the same members are provided with the same reference symbols.

As described above, the display device 220 is always monitoring the image displayed on the host display device and recognizes the host display position. In the operating section 223′, when the return key 235 is operated, the CPU 247 compares the host display position obtained by the monitoring means with the current display position. Then, if the current display position is different from the host display position, the CPU 247 reads data at the host display position from the memory 246 to display the data on the display panel 222.

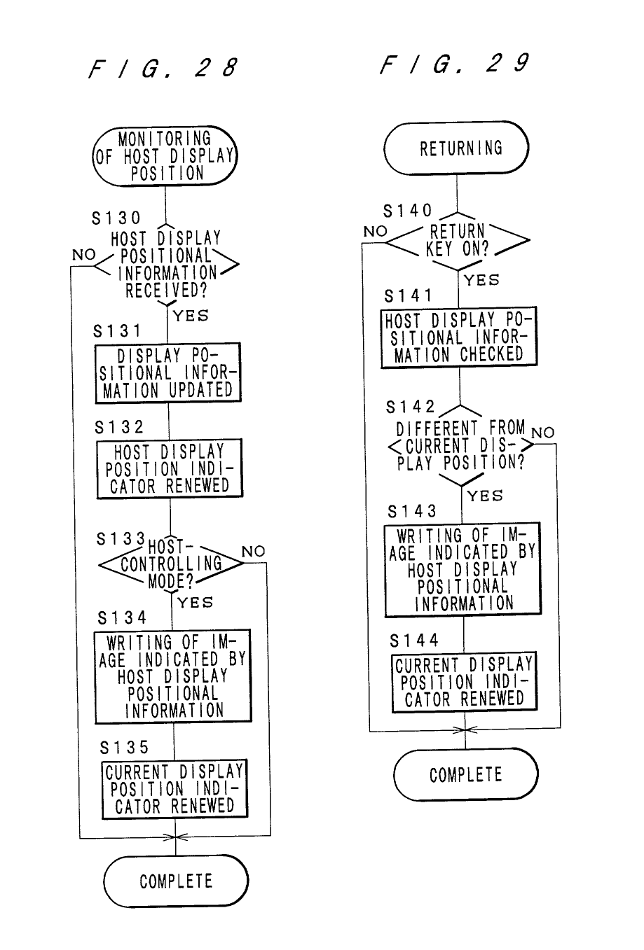

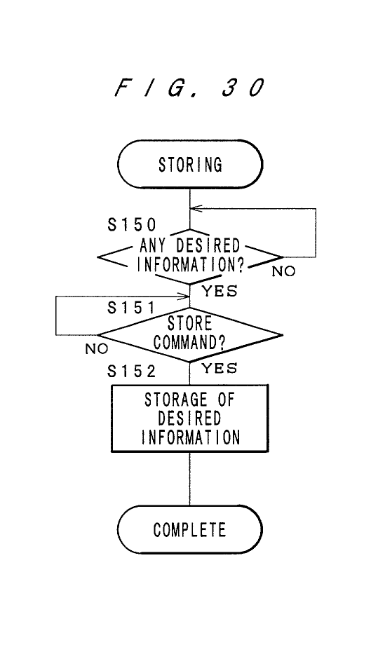

FIG. 29 is a flowchart which shows a returning procedure carried out by the display device 220 which has the operating section223′. When the return key 235 is turned on (“YES” at step S140), positional information about the image on the server 210 detected by the monitoring means is checked at step S141. If the current display position of the display device 220 is different from the display position of the server 210 (“YES” at step S142), the image on the display device 220 is changed to that displayed on the server 210 at step S143, and the current display position indicator 233 is renewed at step S144. Then, this procedure is completed. If the current display position of the display device 220 is equal to that of the server 210 (“NO” at step S142), the procedure is terminated immediately.

Further, it is not necessary to always monitor the host display position, and the display device 220 may be so structured to read the host display positional information when the return key 235 is turned on. In this case, the display device 220 can reduce the electric power consumption in its stand-by state.

With the arrangement above, if the user of the display device 220 changes the display to a desirable page by use of the keys 231a and 231b, the display device 220 can be returned to the page designated by the host immediately only by operating the return key 235 without operating the keys 231a and 231b.

### Storage of Information

After the conference, the participants can store information on the conference in a storage medium such as the memory card 229 or the like by use of the operation keys 231a, 231b and the store key 234. Referring to the flowchart of FIG. 30, a storing procedure is described.

If there is any information (page) which the participant wishes to store (“YES” at step S150), the page number is displayed on the current display position indicator 233. Then, a command to store the information is made by use of the store key 234 (“YES” at step S151), the CPU 247 reads data of the designated page from the memory 246 and writes the data in the storage medium at step S152. By repeating this procedure, the participant can store desirable parts of the documents for the conference in a storage medium.

### Other Embodiments

In the information display system and in the electronic conference system, with respect to each of the sending terminal device and the receiving terminal devices, the external structure, the structure of the screen, the arrangement of operation switches, the network structure, etc. can be arbitrarily designed. As the displays, not only liquid crystal but also other kinds of display means can be used, and the displays do not necessarily have a memory effect.

In the electronic conference system, the following control mode is also possible: while the participants are allowed to look into the documents freely as in the user-controlling mode, the display devices 220 are forced to return to display the same image displayed on the display panel of the server 210 or on the host display device 201 once the server 210 turns a page. With this arrangement, the host can call the participants' attention to the presentation while permitting the participants to look into the documents freely.

The host device comprising the electronic document server and the host display device may be of any structure. Also, with respect to the display devices used by the participants, the structure of the screen and the structure of the operating section can be arbitrarily designed.

Further, although the information display device according to the present invention is suited to be used as a terminal display device for a conference or a seminar, needless to say, the application of the device is not limited to this field.

Each of the display devices 220 may have a sleep mode in which while the display device 220 is capable of detecting whether or not there has been sending of information from the server 210, supply of electric power to the other parts of the device 220 is shut off, which contributes to power saving. In this case, if the display device 220 is so structured to come to an awake state when there is an output from any of the operation keys or from the server 210 and to come back to a sleep state after completing necessary processing, the power switch can be omitted.

Although the present invention has been described in connection with the preferred embodiments above, it is to be noted that various changes and modifications are possible to those who are skilled in the art. Such changes and modifications are to be understood as being within the scope of the present invention.

What is claimed is:

1. An electronic document distributing system in which a sending terminal device is connected to a plurality of receiving terminal devices via a network, wherein:
said sending terminal device comprises:
sending means for sending an electronic document;
deletion prohibiting signal outputting means for outputting a signal to prohibit deletion of the electronic document; and
cancel signal outputting means for outputting a signal to cancel the prohibition of deletion of the electronic document; and
each of said receiving terminal devices comprises:
a memory for storing the electronic document sent from the sending terminal device;
deletion prohibiting means for prohibiting deletion of the stored electronic document in response to the deletion prohibiting signal; and
deletion permitting means for permitting deletion of the electronic document in response to the cancel signal.

2. The electronic document distributing system according to claim 1, wherein:
the cancel signal outputting means comprises an operating member operated by an operator; and
in response to an operation of the operating member, the cancel signal outputting means outputs the cancel signal to cancel the prohibition of deletion of the electronic document.

3. The electronic document distributing system according to claim 2, wherein:
the operating member is a power switch; and
in response to an operation to turn off the power switch, the cancel signal outputting means outputs the cancel signal to cancel the prohibition of deletion of the electronic document.

4. The electronic document distributing system according to claim 1, wherein the deletion prohibiting signal outputting means automatically outputs the deletion prohibiting signal in response to a start of sending electronic document.

5. An electronic document distributing system in which a sending terminal device is connected to a plurality of receiving terminal devices via a network, wherein:
said sending terminal device comprises:
sending means for sending an electronic document; and
deletion prohibiting signal outputting means for outputting a signal to prohibit deletion of the electronic document; and
each of said receiving terminal devices comprises:
a memory for storing the electronic document sent from the sending terminal device;
deletion prohibiting means for prohibiting deletion of the stored electronic document in response to the deletion prohibiting signal;
a power switch; and
deletion permitting means for permitting deletion of the electronic document in response to an operation of the power switch.

6. An electronic document distributing system in which a sending terminal device is connected to a plurality of receiving terminal devices via a network, wherein:
said sending terminal device comprises:
sending means for sending an electronic document; and
sending time signal outputting means for outputting a signal which indicates the time of sending the electronic document; and
each of said receiving terminal devices comprises:
a memory for storing the electronic document sent from the sending terminal device; and
deletion prohibiting means for prohibiting deletion of the stored electronic document based on the sending time signal.

7. The electronic document distributing system according to claim 6, wherein the deletion prohibiting means permits deletion of the electronic document when a specified time passes from the sending time.

8. An electronic document distributing system in which a sending terminal device is connected to a plurality of receiving terminal devices via a network, wherein:
said sending terminal device comprises:
sending means for sending an electronic document; and
deletion prohibiting signal outputting means for outputting a signal to prohibit deletion of the electronic document; and
each of said receiving terminal devices comprises:
a memory for storing the electronic document sent from the sending terminal device;
deletion prohibiting means for prohibiting deletion of the stored electronic document in response to the deletion prohibiting signal;
a detecting section for detecting whether or not the receiving terminal device is connected to the network; and
deletion permitting means for permitting deletion of the electronic document when the detecting section detects that the receiving terminal device is disconnected from the network.

9. A terminal device comprising:
a receiving section for receiving an electronic document;
a first memory section for storing the electronic document received;
a second memory section for receiving and storing a deletion prohibiting signal to prohibit deletion of the electronic document;
deletion prohibiting means for prohibiting deletion of the electronic document stored in the first memory section in response to the deletion prohibiting signal;
a power switch; and
deletion permitting means for permitting deletion of the electronic document stored in the first memory section in response to an operation of the power switch.

10. The terminal device according to claim 9, further comprising:
a display section which has a memory effect; and
a control section for controlling the display section to display a first page of the electronic document when deletion of the electronic document is permitted.

11. A terminal device comprising:
a receiving section for receiving an electronic document;
a first memory section for storing the electronic document received from an external apparatus;
a second memory section for receiving and storing a deletion prohibiting signal to prohibit deletion of the electronic document;
deletion prohibiting means for prohibiting deletion of the electronic document stored in the first memory section in response to the deletion prohibiting signal;
a detecting section for detecting whether or not the terminal device is connected to a network; and
deletion permitting means for permitting deletion of the electronic document stored in the first memory section when the detecting section detects that the terminal device is disconnected from the network.

12. The terminal device according to claim 11, further comprising:
a display section which has a memory effect; and
a control section for controlling the display section to display a first page of the electronic document when deletion of the electronic document is permitted.

13. A terminal device comprising:
a receiving section for receiving an electronic document;
a first memory section for storing the electronic document received from an external apparatus;
a second memory section for receiving and storing a sending time signal which indicates the time of sending the electronic document; and
deletion prohibiting means for prohibiting deletion of the electronic document stored in the first memory section based on the sending time signal.

14. The terminal device according to claim 13, wherein the deletion prohibiting means permits deletion of the electronic document when a specified time passes from the sending time.

15. The terminal device according to claim 14, further comprising:
a display section which has a memory effect; and
a control section for controlling the display section to display a first page of the electronic document when deletion of the electronic document is permitted.

16. An information display device comprising:
a communicating section for communicating with a host device;
a display panel for displaying an image thereon; and
detecting means for detecting information about an image designated by the host device.

17. The information display device according to claim 16, further comprising a display control section for controlling the display device to display desired information on the display panel.

18. The information display device according to claim 17, wherein the display control section controls the display device to display, on the display panel, a desired part of information stored in a storage section provided inside or outside the display device.

19. The information display device according to claim 16, wherein the detecting means comprises:
a first indicator for displaying information about an image designated by the host device; and
a second indicator for displaying information about an image currently displayed on the display panel.

20. An information display device comprising:
a communicating section for communicating with a host device;
a display panel for displaying an image thereon;
a display control section for controlling the display device to display desired information on the display panel; and
display returning means for controlling the display device to display an image designated by the host device on the display panel.

21. The information display device according to claim 20, wherein the display control section controls the display device to display, on the display panel, a desired part of information stored in a storage section provided inside or outside the display device.

22. An information display system comprising:
a plurality of information display devices including:
a first information display device; and
a second information display device which comprises detecting means for detecting information about an image displayed on the first information display device.

23. An information display system comprising:
a host device which has a display panel; and
a terminal device which has a display panel and which is capable of communicating with the host device;
wherein the terminal device comprises detecting means for detecting information about an image displayed on the display panel of the host device.

24. An information display system comprising:
a plurality of information display devices including a first information display device and a second information display device which are capable of displaying desired information independently of each other;
wherein the second information display device comprises display returning means for controlling the second information display device to display an image displayed on the first display device.

25. An information display system comprising:
a host device which has a display panel; and
a terminal device which has a display panel and which is capable of communicating with the host device;
wherein the terminal device comprises a display returning means for controlling the terminal device to display an image displayed on the display panel of the host device.

26. An electronic conference system comprising:
a host device; and
the information display device according to claim 16.

27. The electronic conference system according to claim 26, wherein the host device has a display panel.

28. The electronic conference system according to claim 27, wherein the information about an image designated by the host device is information about an image displayed on the display panel of the host device.

29. An electronic conference system comprising:
a host device; and
the information display device according to claim 20.

30. The electronic conference system according to claim 29, wherein the host device has a display panel.

31. The electronic conference system according to claim 30, wherein the information about an image designated by the host device is information about an image displayed on the display panel of the host device.
